(19) United States
(12) Patent Application Publication
(10) Pub. No.: US 2014/0147593 A1
(43) Pub. Date: May 29, 2014

(54) Liquid Cooled Sputter Apertured Shields

(71) Applicant: INTERMOLECULAR, INC., San Jose, CA (US)

(72) Inventor: Peter Satitpunwaycha, Sunnyvale, CA (US)

(73) Assignee: INTERMOLECULAR, INC., San Jose, CA (US)

(21) Appl. No.: 13/686,072

(22) Filed: Nov. 27, 2012

(51) Int. Cl. B05C 21/00

(52) U.S. Cl. CPC B05C 21/005
USPC 427/282; 118/505; 118/721

(57) ABSTRACT

Methods and systems to control the temperature of a substrate during a physical vapor deposition (PVD) process are provided. A temperature controlled apertured shield can be disposed on the surface of the substrate, surrounding the substrate area that is subjected to the deposition process. The temperature controlled apertured shield can be actively cooled, for example, by a circulated coolant, which can absorb heat from the deposition region and maintaining a desired temperature for the deposited films. In some embodiments, the temperature controlled apertured shield can be used in a high productivity combinatorial (HPC) system, allowing screening of materials and process conditions.

### TECHNICAL FIELD

The present invention relates generally to combinatorial methods for material development.

### BACKGROUND

Sunlight control glasses are commonly used in applications such as building glass windows and vehicle windows, typically offering high visible transmission and low emissivity. High visible transmission can allow more sunlight to pass through the glass windows, thus being desirable in many window applications. Low emissivity can block infrared (IR) radiation to reduce undesirable interior heating.

In low emissivity glasses, IR radiation is mostly reflected with minimum absorption and emission, thus reducing the heat transferring to and from the low emissivity surface. Low emissivity, or low-e, panels are often formed by depositing a reflective layer (e.g., silver) onto a substrate, such as glass. The overall quality of the reflective layer, such as with respect to texturing and crystallographic orientation, is important for achieving the desired performance, such as high visible light transmission and low emissivity (i.e., high heat reflection). In order to provide adhesion, as well as protection, several other layers are typically formed both under and over the reflective layer. The various layers typically include dielectric layers, such as silicon nitride, tin oxide, and zinc oxide, to provide a barrier between the stack and both the substrate and the environment, as well as to act as optical fillers and function as anti-reflective coating layers to improve the optical characteristics of the panel.

The manufacture of low emissivity panels entails the integration and sequencing of many unit processing steps, with potential new process developments. For example, different combinations of infrared reflective layers and antireflective layers can exhibit different optical characteristics, affecting subsequent fabrication processes, and consequently the performance of the low emissivity structures. The precise sequencing and integration of the unit processing steps enables the formation of functional panels meeting desired performance metrics such as visible light transmission, infrared reflection, and reliability.

As part of the discovery, optimization and qualification of each unit process, it is desirable to be able to i) test different materials, ii) test different processing conditions within each unit process module, iii) test different sequencing and integration of processing modules within an integrated processing tool, iv) test different sequencing of processing tools in executing different process sequence integration flows, and combinations thereof in the manufacture of devices such as integrated circuits. In particular, there is a need to be able to test i) more than one material, ii) more than one processing condition, iii) more than one sequence of processing conditions, iv) more than one process sequence integration flow, and combinations thereof, collectively known as “combinatorial process sequence integration”, on a single monolithic substrate without the need of consuming the equivalent number of monolithic substrates per material(s), processing condition(s), sequence(s) of processing conditions, sequence(s) of processes, and combinations thereof. This can greatly improve both the speed and reduce the costs associated with the discovery, implementation, optimization, and qualification of material(s), process(es), and process integration sequence(s) required for manufacturing.

Systems and methods for High Productivity Combinatorial (HPC) processing are described in U.S. Pat. No. 7,544,574 filed on Feb. 10, 2006, U.S. Pat. No. 7,824,935 filed on Jul. 2, 2008, U.S. Pat. No. 7,871,928 filed on May 4, 2009, U.S. Pat. No. 7,902,063 filed on Feb. 10, 2006, and U.S. Pat. No. 7,947,531 filed on Aug. 28, 2009 which are all herein incorporated by reference. Systems and methods for HPC processing are further described in U.S. patent application Ser. No. 11/352,077 filed on Feb. 10, 2006, claiming priority from Oct. 15, 2005, U.S. patent application Ser. No. 11/419,174 filed on May 18, 2006, claiming priority from Oct. 15, 2005, U.S. patent application Ser. No. 11/674,132 filed on Feb. 12, 2007, claiming priority from Oct. 15, 2005, and U.S. patent application Ser. No. 11/674,137 filed on Feb. 12, 2007, claiming priority from Oct. 15, 2005 which are all herein incorporated by reference.

HPC processing techniques have been successfully adapted to wet chemical processing such as etching and cleaning. HPC processing techniques have also been successfully adapted to deposition processes such as physical vapor deposition (PVD), atomic layer deposition (ALD), and chemical vapor deposition (CVD). However, HPC processing techniques have not been successfully adapted to the development of low emissivity panel characteristics, such as optical properties, to evaluate materials and process conditions for optimal low emissivity panel performance.

Therefore, there is a need to apply high productivity combinatorial techniques to the development and investigation of materials for the manufacture of clean energy devices and systems.

### SUMMARY

In some embodiments, methods and systems to control the temperature of a substrate during a deposition process, such as physical vapor deposition (PVD), are provided. A temperature controlled apertured shield can be disposed on the surface of the substrate, surrounding the substrate area that is subjected to the deposition process. The temperature controlled apertured shield can be actively cooled, for example, by a circulated coolant, which can absorb heat from the deposition region and maintain a desired temperature for the deposited films.

In some embodiments, systems and methods for regulating temperature of site isolated regions on a substrate are provided, allowing combinatorial deposition under controlled temperature. A site isolated region can be sealed using a temperature controlled apertured shield, which can be effective for regulating the temperature of the site isolated region, allowing a desired temperature for the deposition process.

In some embodiments, the temperature controlled apertured shield can be made from high thermal conductivity material, and can include inner channels for circulated coolant. By regulating the temperature of the coolant, for example, though a heat exchanger or a cooling mechanism, the apertured shield can be maintained at a desired temperature, leading to a desired temperature of the site isolated region, and preventing oxidation or hazing of the deposited films.

In some embodiments, the temperature controlled apertured shield can be used in a high productivity combinatorial (HPC) system. During normal operation of an HPC system, a reactor module including multiple reactors having temperature controlled apertured shields can create multiple site isolated regions on a substrate surface. The site isolated regions then can be processed with process conditions, device structures, or materials varying in a combinatorial manner.

In some embodiments, a reactor having a temperature controlled apertured shield can press on a region of the substrate surface to create a site isolated region. The temperature controlled apertured shield can regulate the temperature of the site isolated region to prevent degradation of the deposited film.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 illustrates a schematic diagram for implementing combinatorial processing and evaluation using primary, secondary, and tertiary screening.

FIG. 2 is a simplified schematic diagram illustrating a general methodology for combinatorial process sequence integration that includes site isolated processing and/or conventional processing according to some embodiments.

FIG. 3 illustrates a schematic diagram of a substrate that has been processed in a combinatorial manner.

FIG. 4 illustrates a simplified schematic diagram illustrating a PVD process chamber configured to perform combinatorial processing.

FIG. 5 is a simplified schematic diagram illustrating another sputter chamber configured to perform combinatorial processing according to some embodiments.

FIGS. 6A-6B illustrate an example of an apertured shield according to some embodiments.

FIG. 7 illustrates a perspective view of an apertured shield configuration according to some embodiments.

FIG. 8 illustrates a bottom view of a glass substrate having multiple site isolated regions according to some embodiments.

FIGS. 9A-9B illustrate an example of an apertured shield according to some embodiments.

FIGS. 10A-10C illustrate various configurations for apertured shields according to some embodiments.

FIGS. 11A-11C illustrate an example of a sequential combinatorial process according to some embodiments.

FIGS. 12A-12B illustrate top views of the site isolated regions according to some embodiments.

FIG. 13 illustrates a flowchart for processing a substrate according to some embodiments.

FIG. 14 illustrates a flowchart for combinatorially processing a substrate according to some embodiments.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

In some embodiments, combinatorial methods to deposit layers of material, including layers deposited by a physical vapor deposition (PVD) process, are disclosed. The methods can include cooling the substrate in the vicinity of the area to be deposited, for example, by using an apertured shield having circulated coolant. The methods can supplement the substrate cooling process, for example, by a substrate support, and can eliminate or reduce the heating of the substrate, for example, by the ion bombardment of the PVD process.

In the context of the present specification, an aperture shield can include a shielding plate that has one or more apertures. For example, the shielding plate can block materials, e.g., shielding materials from passing through. The apertures can allow materials to pass through the shield plate.

In some embodiments, the methods can utilize an apertured shield having channels within the apertured shield for a circulated fluid coolant. The apertured shield can include an opening for the materials to pass through the shield and be deposited on the substrate. The apertured shield can be placed on the substrate, and the substrate can be cooled by contact.

In the following description, illustrative methods and systems for substrate cooling during a deposition process are shown using simple schematic structures and process flows. Those skilled in the art will appreciate that the description and teachings to follow can be readily applied to any simple or complex testing methodology. The drawings are for illustrative purposes only and do not limit the application of the present invention.

“Combinatorial Processing” generally refers to techniques of differentially processing multiple regions of one or more substrates. Combinatorial processing generally varies materials, unit processes or process sequences across multiple regions on a substrate. The varied materials, unit processes, or process sequences can be evaluated (e.g., characterized) to determine whether further evaluation of certain process sequences is warranted or whether a particular solution is suitable for production or high volume manufacturing.

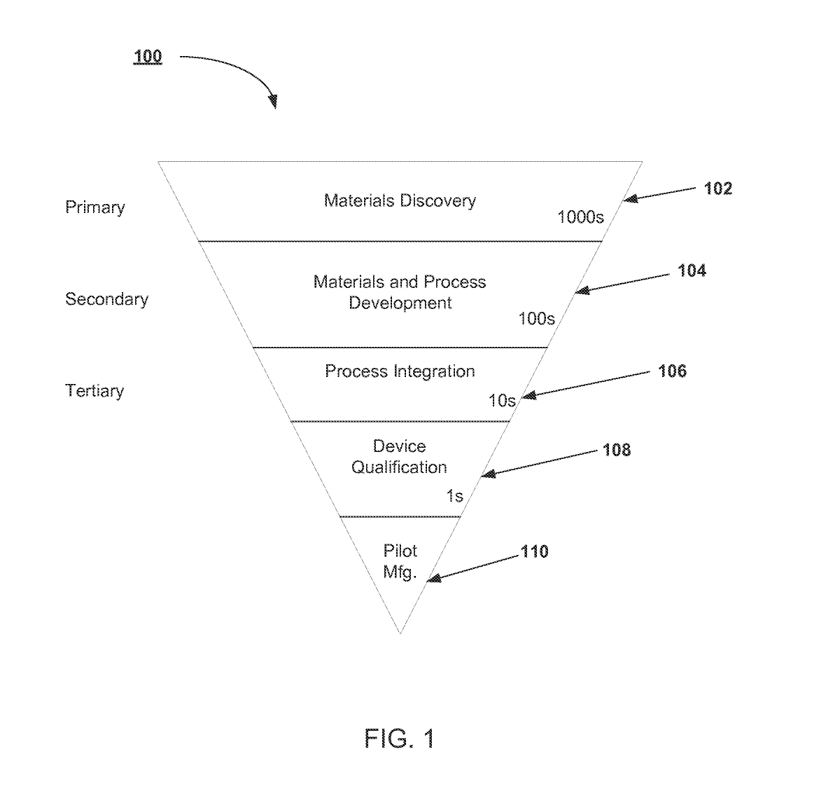

FIG. 1 illustrates a schematic diagram for implementing combinatorial processing and evaluation using primary, secondary, and tertiary screening. The schematic diagram, 100, illustrates that the relative number of combinatorial processes run with a group of substrates decreases as certain materials and/or processes are selected. Generally, combinatorial processing includes performing a large number of processes during a primary screen, selecting promising candidates from those processes, performing the selected processing during a secondary screen, selecting promising candidates from the secondary screen for a tertiary screen, and so on. In addition, feedback from later stages to earlier stages can be used to refine the success criteria and provide better screening results.

For example, thousands of materials are evaluated during a materials discovery stage, 102. Materials discovery stage, 102, is also known as a primary screening stage performed using primary screening techniques. Primary screening techniques may include dividing substrates into coupons and depositing materials using varied processes. The materials are then evaluated, and promising candidates are advanced to the secondary screen, or materials and process development stage, 104. Evaluation of the materials is performed using metrology tools such as electronic testers and imaging tools (i.e., microscopes).

The materials and process development stage, 104, may evaluate hundreds of materials (i.e., a magnitude smaller than the primary stage) and may focus on the processes used to deposit or develop those materials. Promising materials and processes are again selected, and advanced to the tertiary screen or process integration stage, 106, where tens of materials and/or processes and combinations are evaluated. The tertiary screen or process integration stage, 106, may focus on integrating the selected processes and materials with other processes and materials.

The most promising materials and processes from the tertiary screen are advanced to device qualification, 108. In device qualification, the materials and processes selected are evaluated for high volume manufacturing, which normally is conducted on full substrates within production tools, but need not be conducted in such a manner. The results are evaluated to determine the efficacy of the selected materials and processes. If successful, the use of the screened materials and processes can proceed to pilot manufacturing, 110.

The schematic diagram, 100, is an example of various techniques that may be used to evaluate and select materials and processes for the development of new materials and processes. The descriptions of primary, secondary, etc. screening and the various stages, 102-110, are arbitrary and the stages may overlap, occur out of sequence, be described and be performed in many other ways.

This application benefits from High Productivity Combinatorial (HPC) techniques described in U.S. patent application Ser. No. 11/674,137 filed on Feb. 12, 2007 which is hereby incorporated for reference in its entirety. Portions of the '137 application have been reproduced below to enhance the understanding of the present invention. The embodiments described herein enable the application of combinatorial techniques to process sequence integration in order to arrive at a globally optimal sequence of high-k device fabrication process with metal gate by considering interaction effects between the unit manufacturing operations, the process conditions used to effect such unit manufacturing operations, hardware details used during the processing, as well as materials characteristics of components utilized within the unit manufacturing operations. Rather than only considering a series of local optimums, i.e., where the best conditions and materials for each manufacturing unit operation is considered in isolation, the embodiments described below consider interactions effects introduced due to the multitude of processing operations that are performed and the order in which such multitude of processing operations are performed when fabricating a semiconductor device. A global optimum sequence order is therefore derived, and as part of this derivation, the unit processes, unit process parameters and materials used in the unit process operations of the optimum sequence order are also considered.

The embodiments described further analyze a portion or sub-set of the overall process sequence used to manufacture a semiconductor device. Once the subset of the process sequence is identified for analysis, combinatorial process sequence integration testing is performed to optimize the materials, unit processes, hardware details, and process sequence used to build that portion of the device or structure. During the processing of some embodiments described herein, structures are formed on the processed substrate which are equivalent to the structures formed during actual production of the high-k device. For example, such structures may include, but would not be limited to, high-k dielectric layers, metal gate layers, spacers, or any other series of layers or unit processes that create an intermediate structure found on semiconductor devices. While the combinatorial processing varies certain materials, unit processes, hardware details, or process sequences, the composition or thickness of the layers or structures or the action of the unit process, such as cleaning, surface preparation, deposition, surface treatment, etc. is substantially uniform through each discrete region. Furthermore, while different materials or unit processes may be used for corresponding layers or steps in the formation of a structure in different regions of the substrate during the combinatorial processing, the application of each layer or use of a given unit process is substantially consistent or uniform throughout the different regions in which it is intentionally applied. Thus, the processing is uniform within a region (inter-region uniformity) and between regions (intra-region uniformity), as desired. It should be noted that the process can be varied between regions, for example, where a thickness of a layer is varied or a material may be varied between the regions, etc., as desired by the design of the experiment.

The result is a series of regions on the substrate that contain structures or unit process sequences that have been uniformly applied within that region and, as applicable, across different regions. This process uniformity allows comparison of the properties within and across the different regions such that the variations in test results are due to the varied parameter (e.g., materials, unit processes, unit process parameters, hardware details, or process sequences) and not the lack of process uniformity. In the embodiments described herein, the positions of the discrete regions on the substrate can be defined as needed, but are preferably systematized for ease of tooling and design of experimentation. In addition, the number, variants and location of structures within each region are designed to enable valid statistical analysis of the test results within each region and across regions to be performed.

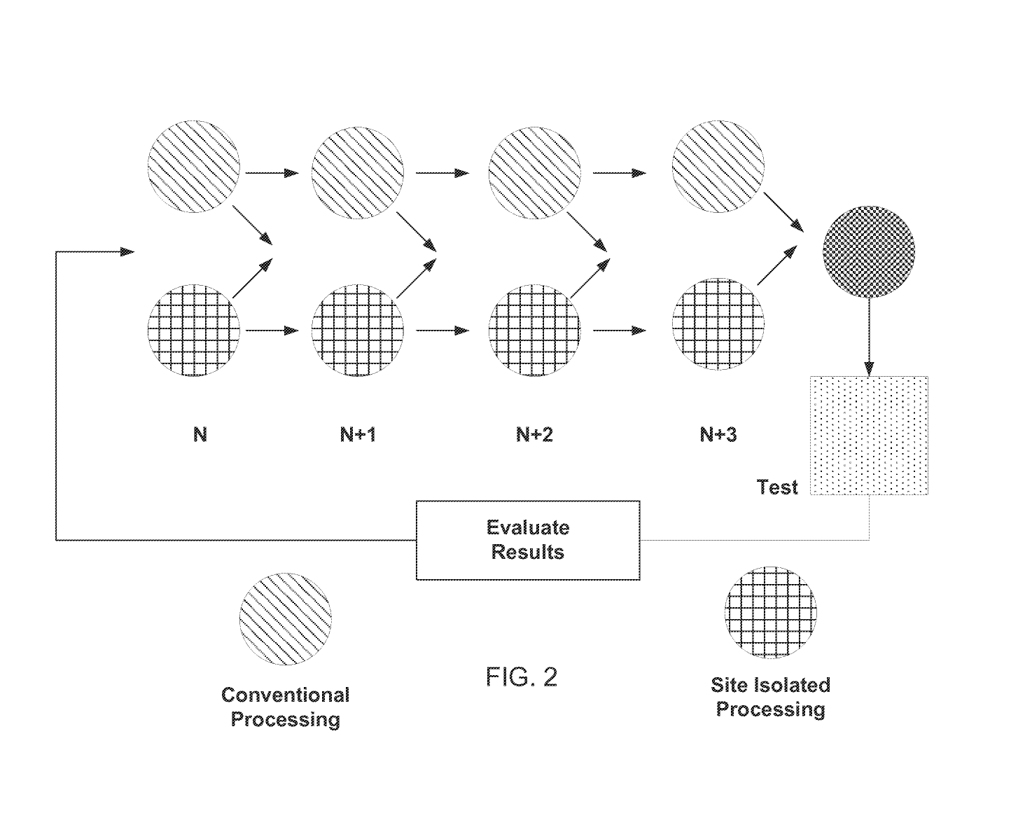

FIG. 2 is a simplified schematic diagram illustrating a general methodology for combinatorial process sequence integration that includes site isolated processing and/or conventional processing according to some embodiments. In some embodiments, the substrate is initially processed using conventional process N. In some embodiments, the substrate is then processed using site isolated process N+1. During site isolated processing, an HPC module may be used, such as the HPC module described in U.S. patent application Ser. No. 11/352,077 filed on Feb. 10, 2006. The substrate can then be processed using site isolated process N+2, and thereafter processed using conventional process N+3. Testing is performed and the results are evaluated. The testing can include physical, chemical, acoustic, magnetic, electrical, optical, etc. tests. From this evaluation, a particular process from the various site isolated processes (e.g. from steps N+1 and N+2) may be selected and fixed so that additional combinatorial process sequence integration may be performed using site isolated processing for either process N or N+3. For example, a next process sequence can include processing the substrate using site isolated process N, conventional processing for processes N+1, N+2, and N+3, with testing performed thereafter.

It should be appreciated that various other combinations of conventional and combinatorial processes can be included in the processing sequence with regard to FIG. 2. That is, the combinatorial process sequence integration can be applied to any desired segments and/or portions of an overall process flow. Characterization, including physical, chemical, acoustic, magnetic, electrical, optical, etc. testing, can be performed after each process operation, and/or series of process operations within the process flow as desired. The feedback provided by the testing is used to select certain materials, processes, process conditions, and process sequences and eliminate others. Furthermore, the above flows can be applied to entire monolithic substrates, or portions of monolithic substrates such as coupons.

Under combinatorial processing operations the processing conditions at different regions can be controlled independently. Consequently, process material amounts, reactant species, processing temperatures, processing times, processing pressures, processing flow rates, processing powers, processing reagent compositions, the rates at which the reactions are quenched, deposition order of process materials, process sequence steps, hardware details, etc., can be varied from region to region on the substrate. Thus, for example, when exploring materials, a processing material delivered to a first and second region can be the same or different. If the processing material delivered to the first region is the same as the processing material delivered to the second region, this processing material can be offered to the first and second regions on the substrate at different concentrations. In addition, the material can be deposited under different processing parameters. Parameters which can be varied include, but are not limited to, process material amounts, reactant species, processing temperatures, processing times, processing pressures, processing flow rates, processing powers, processing reagent compositions, the rates at which the reactions are quenched, atmospheres in which the processes are conducted, an order in which materials are deposited, hardware details of the gas distribution assembly, etc. It should be appreciated that these process parameters are exemplary and not meant to be an exhaustive list as other process parameters commonly used in semiconductor manufacturing may be varied.

As mentioned above, within a region, the process conditions are substantially uniform, in contrast to gradient processing techniques which rely on the inherent non-uniformity of the material deposition. That is, the embodiments, described herein locally perform the processing in a conventional manner, e.g., substantially consistent and substantially uniform, while globally over the substrate, the materials, processes, and process sequences may vary. Thus, the testing will find optimums without interference from process variation differences between processes that are meant to be the same. It should be appreciated that a region may be adjacent to another region in one embodiment or the regions may be isolated and, therefore, non-overlapping. When the regions are adjacent, there may be a slight overlap wherein the materials or precise process interactions are not known, however, a portion of the regions, normally at least 50% or more of the area, is uniform and all testing occurs within that region. Further, the potential overlap is only allowed with material of processes that will not adversely affect the result of the tests. Both types of regions are referred to herein as regions or discrete regions.

In some embodiments, layers having different materials and/or process conditions are fabricated and tested to evaluate their characteristics and behaviors, for example, to identify their electrical conductivity, or their surface roughness.

In some embodiments, methods to deposit layers having different materials on a substrate are provided, including PVD processes. PVD processes can employ plasma ambient and ion bombardment for sputter materials from a target to be deposited on a substrate. The plasma ambient and ion bombardment can heat the substrate, and degrade the deposited layer characteristics.

In some embodiments, combinatorial workflows for evaluating material characteristics and behaviors using PVD processes are provided. High productivity combinatorial processing can be a fast and economical technique for screening materials to determine their proper process integration in advanced semiconductor devices.

Combinatorial processing can be used to produce and evaluate different materials, chemicals, processes, process and integration sequences, and techniques related to semiconductor fabrication. For example, combinatorial processing can be used to determine optimal processing parameters (e.g., power, time, reactant flow rates, temperature, etc.) of dry processing techniques such as dry etching (e.g., plasma etching, flux-based etching, reactive ion etching (RIE)) and dry deposition techniques (e.g., physical vapor deposition (PVD), chemical vapor deposition (CVD), atomic layer deposition (ALD), etc.). Combinatorial processing can be used to determine optimal processing parameters (e.g., time, concentration, temperature, stirring rate, etc.) of wet processing techniques such as wet etching, wet cleaning, rinsing, and wet deposition techniques (e.g., electroplating, electroless deposition, chemical bath deposition, etc.).

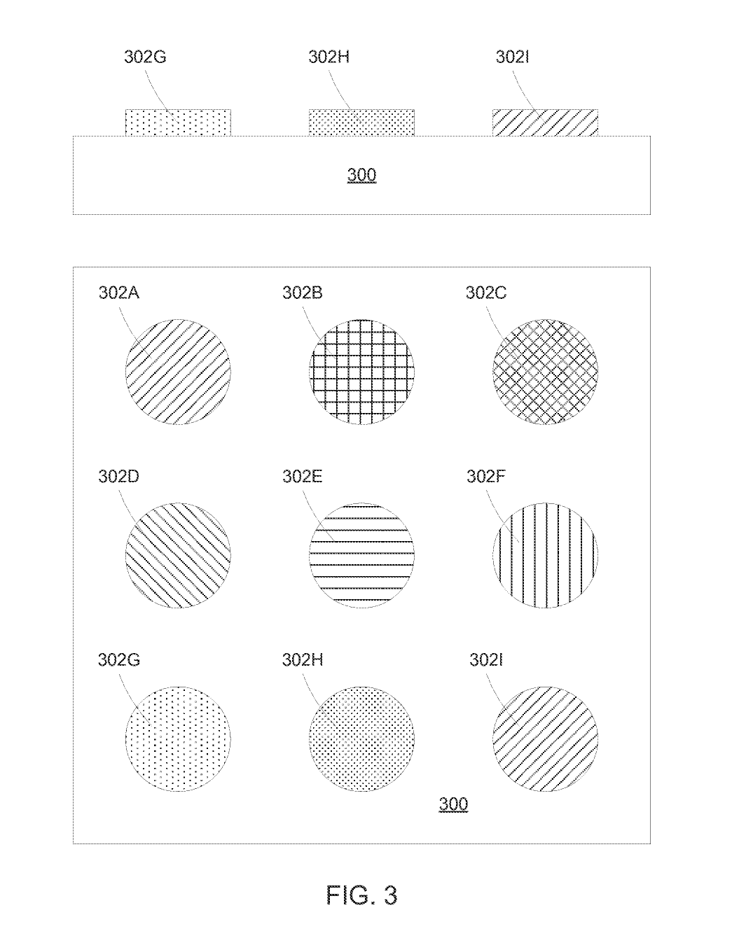

FIG. 3 illustrates a schematic diagram of a substrate that has been processed in a combinatorial manner. A substrate, 300, is shown with nine site isolated regions, 302A-302I, illustrated thereon. Although the substrate 300 is illustrated as being a generally square shape, those skilled in the art will understand that the substrate may be any useful shape such as round, rectangular, etc. The lower portion of FIG. 3 illustrates a top down view while the upper portion of FIG. 3 illustrates a cross-sectional view taken through the three site isolated regions, 302G-302I. The shading of the nine site isolated regions illustrates that the process parameters used to process these regions have been varied in a combinatorial manner. The substrate may then be processed through a next step that may be conventional or may also be a combinatorial step as discussed earlier with respect to FIG. 2.

In some embodiments, the dielectric layer is formed through a deposition process, such as chemical vapor deposition (CVD), atomic layer deposition (ALD), or physical vapor deposition (PVD). The metal electrode layer can be formed by PVD, CVD or ALD through a shadow mask or by a lithography patterning process.

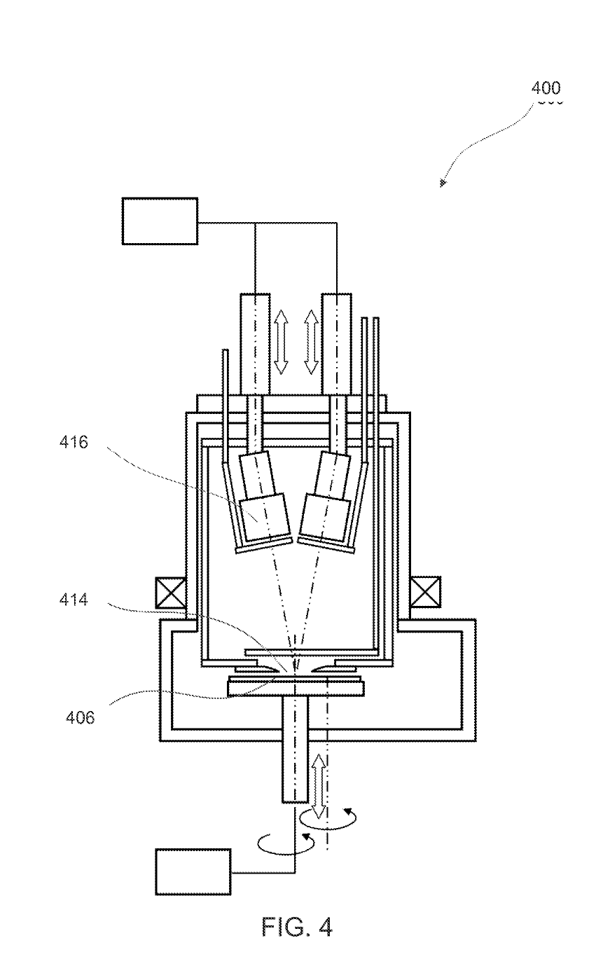

FIG. 4 illustrates a simplified schematic diagram illustrating a PVD process chamber configured to perform combinatorial processing. The PVD system 400, sometimes commonly called a sputter system, generally includes a process chamber, one or more sputtering sources, and a transport system capable of positioning the substrate such that any area of the substrate can be exposed to sputtered material. The apparatus can further include an apertured shield positioned under each sputtering source, with the apertured shield oriented normal to the substrate and located adjacent to but not touching the substrate. The apertured shield typically has an opening smaller than the substrate so that discrete regions of the substrate can be subjected to distinct process conditions in a combinatorial manner. However, there is no particular limit on the size of the openings or the apertured shield. Typical openings can range from a minimum of about 10 mm in one dimension, and can be square, round, or rectangular, for example. For combinatorial processing, the openings are small enough such that films can be deposited on a plurality of site-isolated regions on a substrate. For high deposition rate sputtering to coat an entire substrate, the openings can be up to approximately full substrate size.

The process chamber provides a controlled atmosphere so that sputtering can be performed at any gas pressure or gas composition necessary to perform the desired combinatorial processing. Typical processing gases include argon, oxygen, hydrogen, or nitrogen. However, additional gases can be used as desired for particular applications.

The transport system can include a substrate support capable of controlling substrate temperature up to about 550 C, and applying a bias voltage of a few hundred volts.

In a sputter system 400, a plurality of sputtering sources 416 are positioned at an angle so that they can be aimed through a single apertured shield 414 to a site-isolated region on a substrate 406. The sputtering sources 416 are positioned about 100-300 mm from the apertured shield 414 to ensure uniform flux to the substrate within the site-isolated region. Details of the combinatorial PVD system are described in U.S. patent application Ser. No. 12/027,980 filed on Feb. 7, 2008 and U.S. patent application Ser. No. 12/028,643 filed on Feb. 8, 2008, which are herein incorporated by reference.

In some embodiments, a deposition process can be performed in the sputter system 400 in a combinatorial manner. The combinatorial deposition process generally includes exposing a first site-isolated region of a surface of a substrate to material from a sputtering source under a first set of process parameters, and exposing a second site-isolated region of a surface of the substrate to material from a sputtering source under a second set of process parameters. During exposure of the surface of the substrate to the sputtering source, the remaining area of the substrate is not exposed to the material from the sputtering target, enabling site-isolated deposition of sputtered material onto the substrate. The combinatorial process can further include exposing three or more site-isolated regions of the substrate to material from a sputtering source under distinct sets of process parameters. The combinatorial process can further comprise depositing additional layers onto any site-isolated region to build multi-layered structures if desired. In this manner, a plurality of process conditions to deposit one or a plurality of layers can be explored on a single substrate under distinct process parameters.

The process parameters that can be combinatorially varied generally comprise sputtering parameters, sputtering atmosphere parameters, substrate parameters, or combinations thereof. Sputtering parameters typically comprise exposure times, power, sputtering target material, target-to-substrate spacing, or a combination thereof. Sputtering atmosphere parameters typically comprise total pressure, carrier gas composition, carrier gas flow rate, reactive gas composition, reactive gas flow rate, or combinations thereof. The reactive gas flow rate can be set to greater than or equal to zero in order to vary the reactive gas composition in an inert carrier gas. The substrate parameters typically comprise substrate material, surface condition (e.g., roughness), substrate temperature, substrate bias, or combinations thereof.

Substrates can be a conventional round 200 mm, 300 mm, or any other larger or smaller substrate/wafer size. In other embodiments, substrates may be square, rectangular, or other shape. One skilled in the art will appreciate that substrate may be a blanket substrate, a coupon (e.g., partial wafer), or even a patterned substrate having predefined regions. In some embodiments, a substrate may have regions defined through the processing described herein.

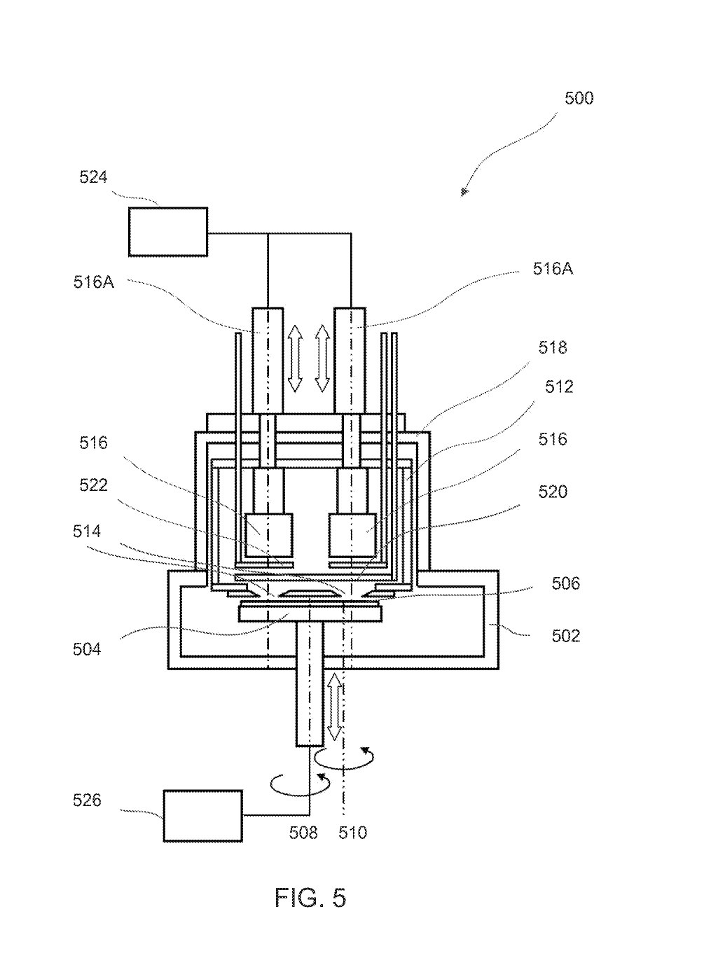

FIG. 5 is a simplified schematic diagram illustrating another sputter chamber configured to perform combinatorial processing according to some embodiments. Processing chamber 500 includes a bottom chamber portion 502 disposed under top chamber portion 518. Within bottom portion 502, substrate support 504 is configured to hold a substrate 506 disposed thereon and can be any known substrate support, including but not limited to a vacuum chuck, electrostatic chuck or other known mechanisms. Substrate support 504 is capable of both rotating around its own central axis 508 (referred to as “rotation” axis), and rotating around an exterior axis 510 (referred to as “revolution” axis). Such dual rotary substrate support can be useful for combinatorial processing using site-isolated mechanisms. Other substrate supports, such as an X-Y table, can also be used for site-isolated deposition. In addition, substrate support 504 may move in a vertical direction. It should be appreciated that the rotation and movement in the vertical direction may be achieved through known drive mechanisms which include magnetic drives, linear drives, worm screws, lead screws, a differentially pumped rotary feed through drive, etc. Power source 526 provides a bias power to substrate support 504 and substrate 506, and produces a bias voltage on substrate 506. Substrate 506 can be a conventional round 200 mm, 300 mm, or any other larger or smaller substrate/wafer size. In other embodiments, substrate 506 can be square, rectangular, or other suitable shape. One skilled in the art will appreciate that substrate 506 can be a blanket substrate, a coupon (e.g., partial wafer), or even a patterned substrate having predefined regions. In another embodiment, substrate 506 can have regions defined through the processing described herein.

Top chamber portion 518 of chamber 500 in FIG. 5 includes shield 512, which defines a confinement region over a radial portion of substrate 506. Shield 512 is a sleeve having a base (optionally integrated with the shield) and an optional top within chamber 500 that can be used to confine a plasma generated therein. The generated plasma dislodges atoms from a sputtering target (causing material to be ejected from the sputtering target) and the sputtered atoms are deposited on a site-isolated region of the substrate 506. Deposition can be performed in an inert gas atmosphere (e.g., an argon carrier gas) to deposit materials such as pure metals, or in the presence of reactive gases such as nitrogen or oxygen to deposit molecules such as metal oxides or metal nitrides. Neutral atoms or molecules (optionally in an excited electronic state) can be deposited. Alternatively, ions can be deposited, in which case a substrate bias voltage can be used advantageously to tune the energy of the ions arriving at the site-isolated region. Chamber pressure and gas flow rates can be adjusted to control the process; for example, the stoichiometry of layers formed in a reactive atmosphere can be tuned by adjusting the relative flow rate of the reactive gas(es).

Shield 512 is capable of being moved in and out of chamber 500, i.e., the shield is a replaceable insert. Shield 512 includes an optional top portion, sidewalls and a base. In some embodiments, shield 512 is configured in a cylindrical shape, however, the shield may be any suitable shape and is not limited to a cylindrical shape.

The base of shield 512 includes a plurality of openings 514 in an aperture plate through which one or more site-isolated region of the surface of substrate 506 is exposed for deposition or some other suitable semiconductor processing operations. Aperture shutter 520 is moveably disposed over the base of shield 512. In some embodiments, aperture shutter 520 can be moved across a bottom surface of the base of shield 512 in order to cover or expose one or more openings 514. Typically, only one opening is uncovered at any one time to prevent cross-contamination between site-isolated regions. In some embodiments, aperture shutter 520 is controlled through an arm extension which moves the aperture shutter to expose or cover an opening 514. It should be noted that although a single opening per sputtering source is illustrated, multiple openings may be included for each sputtering source. Each opening can be associated with a dedicated aperture shutter or an aperture shutter can be configured to cover more than one opening simultaneously or separately. Alternatively, opening 514 can be a larger opening and aperture shutter 520 can extend with that opening to either completely cover the opening or place one or more fixed aperture shutters within that opening for processing the defined regions. The dual rotary substrate support 504 is useful to the site-isolating mechanism, and allows any location of the substrate or wafer to be placed under the opening 514. Hence, site-isolated deposition is possible at any location on the wafer/substrate.

A sputtering source shutter, 522 can also be included. Sputtering source shutter 522 functions to seal off a deposition source when the deposition source may not be used for the processing in some embodiments. For example, two sputtering sources 516 are illustrated in FIG. 5. Sputtering sources 516 are moveable in a vertical direction so that one or both of the sources can be lifted from the slots of the shield. While two sputtering sources are illustrated, any number of sputtering sources can be included, constrained only by space limitations, e.g., one, three, four or more sputtering sources can be included. Typical embodiments for combinatorial processing can include 4 to 6 sputtering sources. Where more than one sputtering source is included, the plurality of sputtering sources may be referred to as a cluster of sputtering sources. Sputtering source shutter 522 can be moved to isolate the lifted sputtering sources from the processing area defined within shield 512. In this manner, the sputtering sources can be isolated from certain processes when desired. It should be appreciated that sputtering source shutter 522 can be integrated with the top of the shield 512 to cover the opening as the sputtering source is lifted or a sputtering source shutter 522 can be used for each site-isolated region.

Top chamber portion 518 of chamber 500 of FIG. 5 includes sidewalls and a top plate which house shield 512. Arm extensions 516a, which are fixed to sputtering sources 516 can be attached to a suitable drive, e.g., lead screw, worm gear, etc., configured to vertically move sputtering sources 516 toward or away from a top plate of top chamber portion 518.

Low thermal conductivity substrates, such as glass panels, can be overheated due to the ion bombardment during long sputtered deposition period. Substrate cooling through the pedestal can be inadequate, especially for thick glass substrates. The high substrate temperature can potentially affect the quality of the deposited films, such as film oxidation or hazing.

In some embodiments, methods and systems to control the temperature of a substrate during a physical vapor deposition (PVD) process are provided. A temperature controlled apertured shield can be used to cool the substrate surface at the area surrounding the deposition area. The apertured shield can include a circulated fluid, e.g., coolant, which can maintain the apertured shield at a desired temperature, such as room temperature or below 100 C. The low temperature can improve the deposition characteristics, for example, to prove a silver layer with smooth surface and high conductivity for low emissivity glass panels. Alternatively, the circulated fluid can be used to heat the substrate.

In some embodiments, the temperature controlled apertured shield can be made from high thermal conductivity material, and can include inner channels for circulated coolant. By regulating the temperature of the coolant, for example, though a heat exchanger or a cooling mechanism, the apertured shield can be maintained at a desired temperature, leading to a desired temperature of the site isolated region, and preventing oxidation or hazing of the deposited films. By using a high thermal conductivity material, the temperature of the apertured shield can be uniform, and heat can be dissipated quickly by the circulated coolant. The apertured shield can be made from materials having thermal conductivity greater than that of glass, e.g., greater than about 0.1 W/(m·K). The apertured shield can be made from materials having thermal conductivity greater than about 1 W/(m·K).

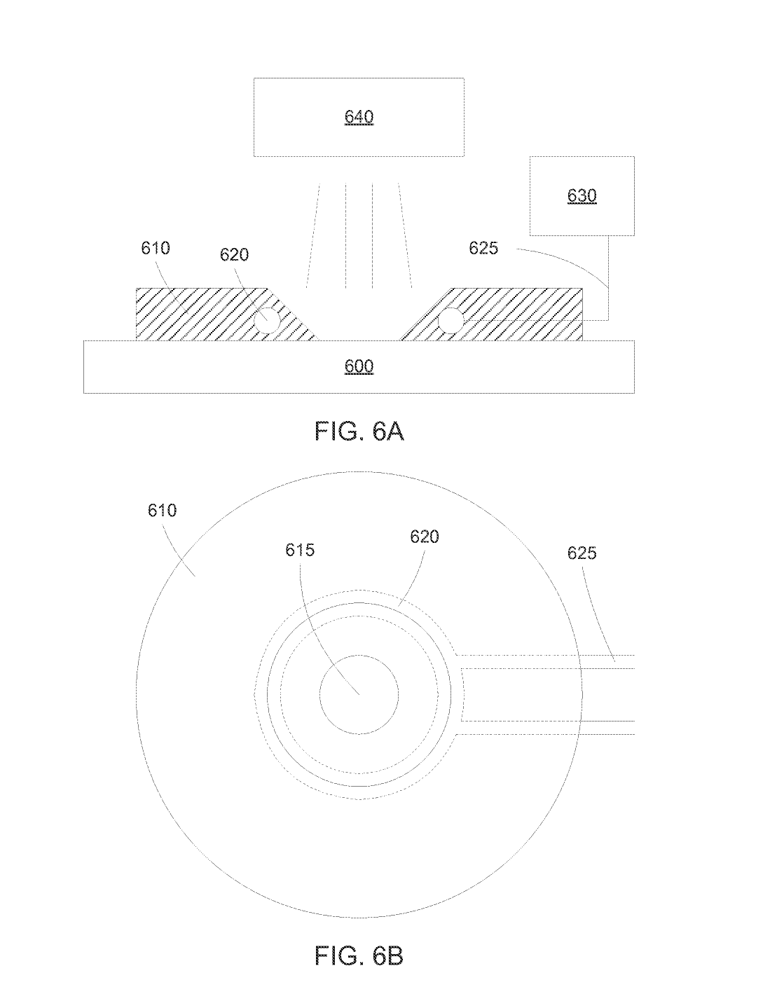

FIGS. 6A-6B illustrate an example of an apertured shield according to some embodiments. An apertured shield 610 can be placed on a substrate 600 during a process, such as a PVD process. For example, a sputtering target 640 can be used to deposit material and form a layer on the substrate 600, through an opening 615 of the apertured shield 610. The opening 615 is shown having a circular shape, but any shape can be used, such as hexagonal or square. The apertured shield 610 can form intimate contact with the substrate 600, allowing heat transfer between the apertured shield and the substrate. For example, the bottom surface of the apertured shield, e.g., the surface of the apertured shield that is configured to be placed on the substrate, can be flat and smooth, for example, to improve the heat conduction between the substrate and the apertured shield. Channels 620 can be provided within the apertured shield 610 to control the temperature of the apertured shield, for example, through circulating fluid supplied from a reservoir 630 to conduits 625. The channels 620 can be configured to surround the opening 615 of the apertured shield, allowing effective cooling of the substrate region exposed by the opening 615. The circulating fluid can include a gas, such as air, or a liquid, such as water. A heater or a cooler can be provided to regulate the temperature of the circulating fluid, maintaining the apertured shield at a desired temperature, such as room temperature or a temperature below 100 C.

Without the temperature controlled apertured shield, the substrate can heat up during the deposition process, for example, due to the ion bombardment from the target 640. In some embodiments, the temperature of the substrate can be controlled through a substrate support. The apertured shield can further regulate the substrate temperature, especially for low thermal conductivity substrates such as glass or ceramic. Since the apertured shield can regulate the temperature of the substrate top surface, e.g., the surface where the deposition occurs, the apertured shield can be used for various substrates, including substrates having low thermal conductivity property.

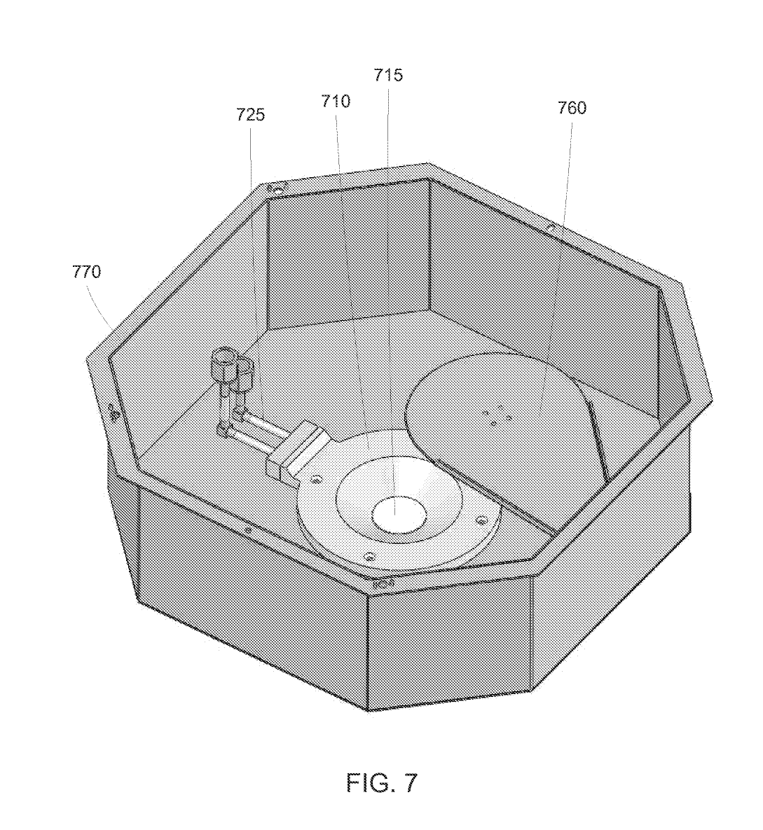

FIG. 7 illustrates a perspective view of an apertured shield configuration according to some embodiments. An apertured shield 710 having an opening 715 can include conduits 725 for regulating the temperature. A movable shield 760, such as a rotatable shield, can be provided to shield the opening 715 and/or the apertured shield 710 from the atoms sputtered from a target (not shown). The shield 760 can be used to prevent deposition on the opening area 715, for example, during stabilization time. In addition, another shield 770 can be used to surround the apertured shield 710. The shield 770 can be used to prevent deposition on the substrate at areas different from the opening area 715. For example, the shield 770 can be used in combinatorial processing, shielding the substrate during the deposition of a site isolated region defined by the opening 715.

In some embodiments, the shield 770 can be placed on the substrate, with the opening 715 of the apertured shield defining a site isolated region. After the deposition, the shield 770 can be moved to another location, with the opening 715 of the apertured shield defining another site isolated region. The process can be repeated until the deposition process can be performed on all site isolated regions.

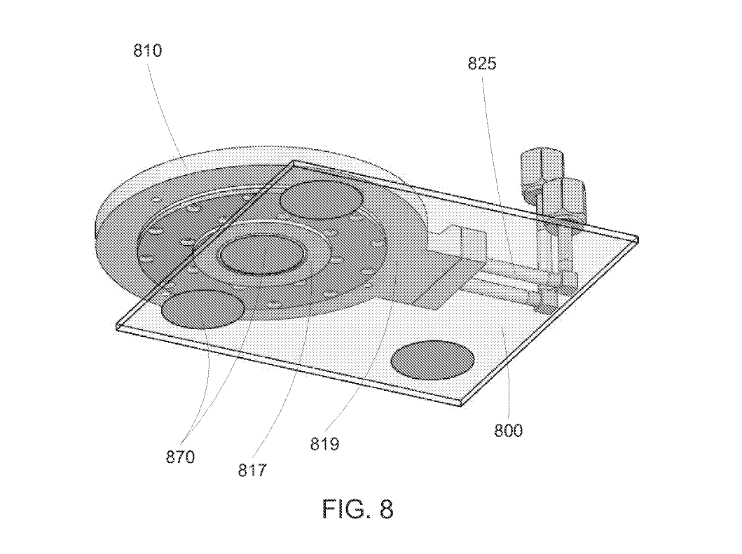

FIG. 8 illustrates a bottom view of a glass substrate having multiple site isolated regions according to some embodiments. An apertured shield 810 can be placed on a substrate 800, and can be moved to form multiple site isolated regions 870. The apertured shield can include an inner portion 817, which surrounds the opening that can be used to form the site isolated region 870. The inner portion 817 can contact the substrate for cooling the substrate, especially the site isolated region 815. The apertured shield 810 can be cooled by a circulated coolant, delivered to the apertured shield 810 through conduits 825. The apertured shield can include outer portion 819, which can be used to support the apertured shield, and/or shielding the area of the substrate in the vicinity of the site isolated region from being deposited. Additional surrounding shields can be used to protect the substrate (not shown). The outer region can include a gap, and thus does not contact the substrate, for example, to prevent damaging nearby site isolated regions.

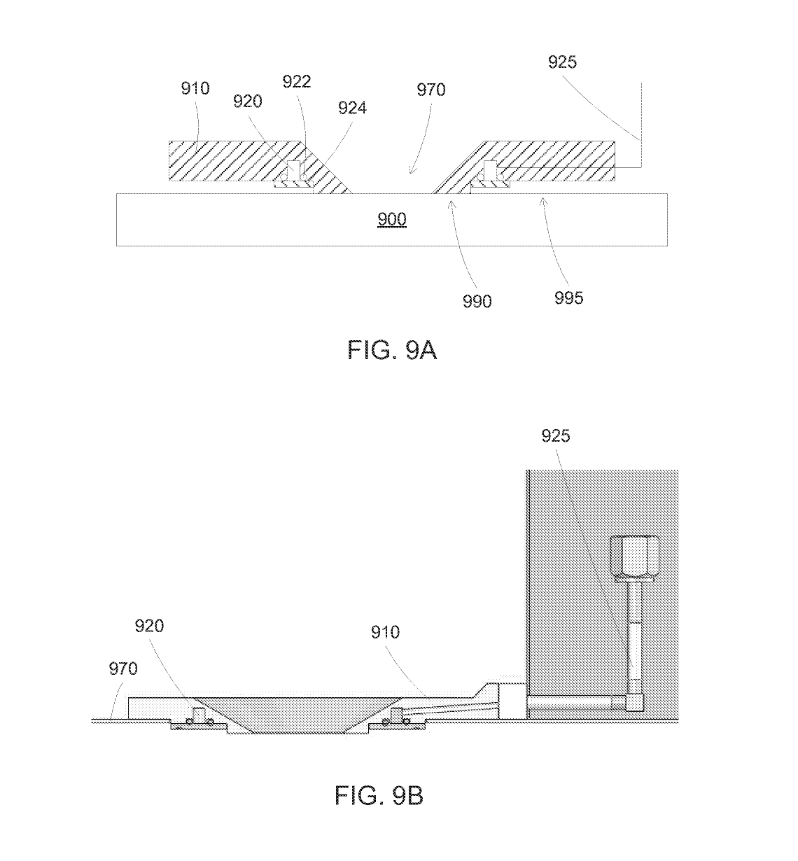

FIGS. 9A-9B illustrate an example of an apertured shield according to some embodiments. An apertured shield 910 can be placed on a substrate 900. The apertured shield 910 can cover most area of the substrate, leaving a site isolated region 970 exposed for deposition. For example, surrounding shield 970 can protect a larger area of the substrate from being exposed to a target. Channels 920 can be provided in the apertured shield for a circulated fluid. A cover plate 924 can be used to encapsulate the channel 920, together with seal 922, such as an o-ring seal, to prevent leakage of fluid. Conduits 925 can be used to deliver the circulated fluid to and from the apertured shield. The apertured shield 910 can include an inner portion 990, which surrounds the site isolated region 970 and which contacts the substrate for cooling. The apertured shield 910 can include an outer portion 995, which is outside the inner portion and serves to protect the substrate from being deposited with materials from the target during the deposition of the site isolated region 970.

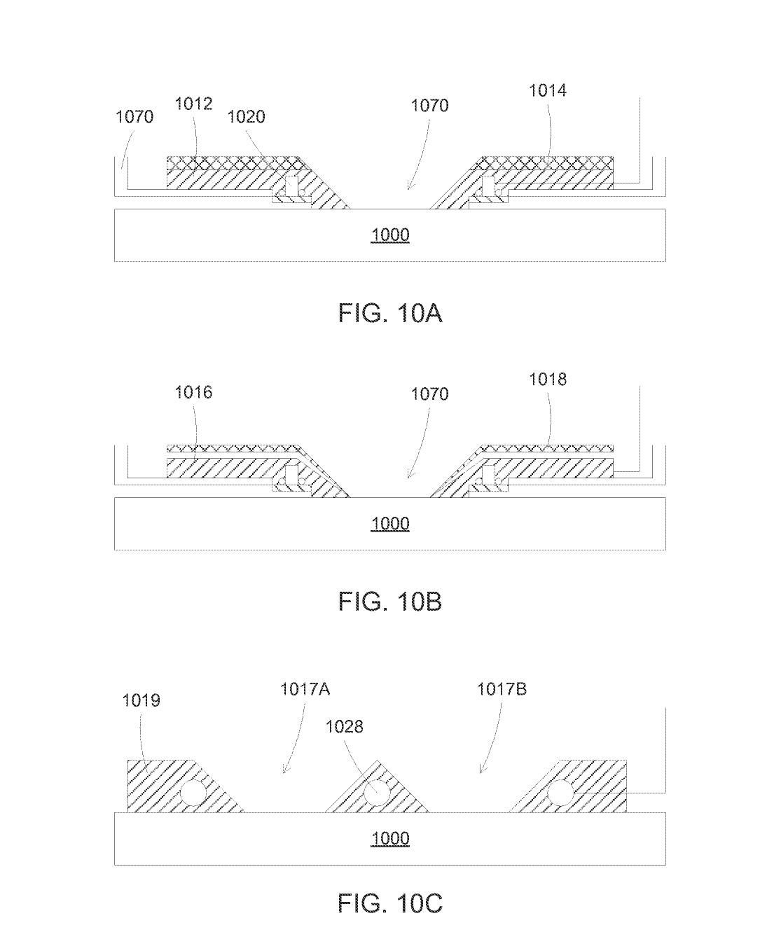

FIGS. 10A-100 illustrate various configurations for apertured shields according to some embodiments. In FIG. 10A, an apertured shield can include a bottom portion 1012 which is made from materials having high thermal conductivity. The apertured shield can include a top portion 1014, which is made from materials having lower thermal conductivity than that of the bottom portion 1012. The high thermal conductivity of the bottom portion can allow fast thermal transfer from the substrate to the coolant channels 1020. The low thermal conductivity of the bottom portion can protect the apertured shield from being heated, for example, by the ion bombardment from the target during deposition. Surrounding shield can be used to prevent deposition on unintended areas on the substrate, e.g., on areas different from the site isolated region 1070. The apertured shield can include an inner portion that contacts the substrate, and an outer portion that forms a gap with the substrate.

In FIG. 10B, the apertured shield can include a bottom portion 1016, which can be made from high thermal conductivity materials. A removable top portion 1018 can be placed on the bottom portion 1016. The top portion 1018 can be made of lower thermal conductivity materials. In addition, the top portion 1018 can form a gap with the bottom portion 1016, further insulating the top portion from the bottom portion. The top portion 1018 can also be removable, for example, to be periodically replaced and cleaned of deposited materials.

In FIG. 10C, the apertured shield 1019 can include multiple openings 1017A and 1017B, for example, to permit simultaneous deposition on multiple site isolated regions. Channels 1028 can surround the multiple openings to allow effective cooling of the substrate area that is exposed to the target for deposition.

In some embodiments, methods and systems for combinatorially processing a substrate are provided. For example, in a first processing step, a first site isolated region of a substrate, defined by an apertured shield, is processed, for example, by depositing a layer. In a second processing step, sequentially executed after the first step, a second site isolated region of the substrate, contiguous (e.g., adjacent with or without overlapping) to the first region, is processed. The second site isolated region of the substrate is also defined by the apertured shield, which moves to process the second region. The first region and the second region may be adjacent to one another, or may be separated by a gap. The process parameters used to process the multiple site isolated regions, such as variations of materials, unit processes, and process sequences, can be varied in a combinatorial manner. The combinatorial process can provide a simple and cost effective screening of manufacturing operations to derive optimum manufacturing methods or integration sequences.

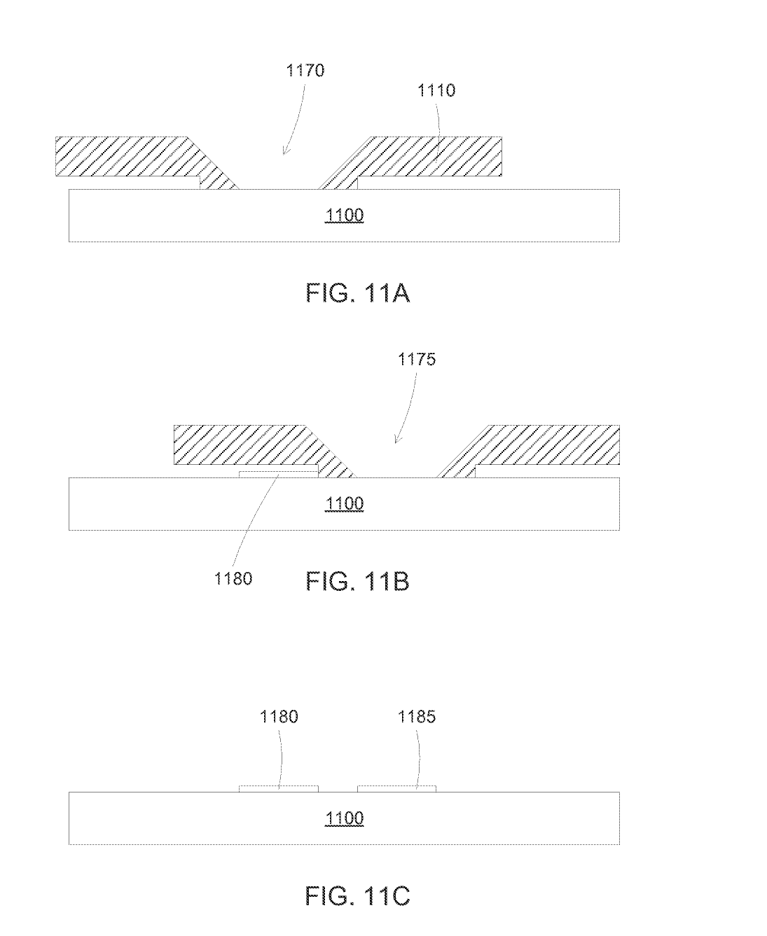

FIGS. 11A-11C illustrate an example of a sequential combinatorial process according to some embodiments. In FIG. 11A, a first process is performed on a substrate 1100, including placing an apertured shield 1110 on the substrate 1110 for processing a site isolated region 1170. The apertured shield 1110 is shown as a schematic representation without all the details for simplicity purposes. In reality, the apertured shield 1110 can include other components and elements described in this specification, such as cooling channels, cooling conduits, cooling reservoir, cooling circulation mechanism, and top and bottom shields.

In FIG. 11B, after depositing a layer 1180 on the site isolated region 1170 from the first process, a second process is sequentially performed on the substrate 1100, after the first process. For example, the apertured shield 1110 can move relative to the substrate 1100 to be positioned on an adjacent region 1175. As shown, the apertured shield 1110 is positioned next to the deposited layer 1180, which can be formed based to deposition on the site isolated region 1170. The positioning of the apertured shield can allow processing the substrate without touching the layers, e.g., 1180, on the site isolated regions, e.g., 1170.

FIG. 11C illustrates the configuration of the deposited layers 1180 and 1185, forming site isolated regions on the substrate 1100. The deposited layers 1180 and 1185 are formed by a deposition on the site isolated regions 1170 and 1175 in the first and second process, respectively. The site isolated regions are separated by the thickness of the inner portion of the apertured shield, e.g., the portion of the apertured shield that contacts the substrate.

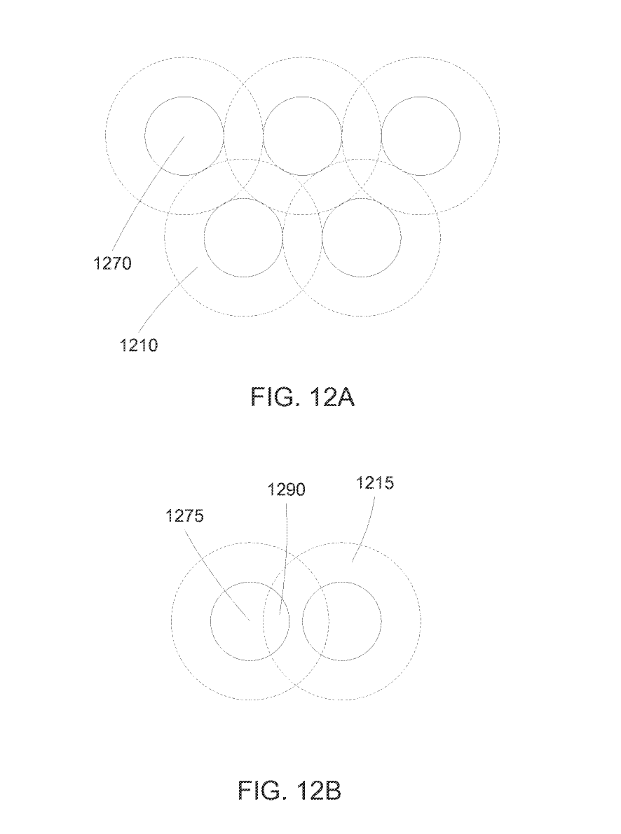

In some embodiments, a step-and-repeat method can be used to achieve multiple site isolated regions on a substrate using an apertured shield. FIGS. 12A-12B illustrate top views of the site isolated regions according to some embodiments. In FIG. 12A, the site isolated regions 1270 are separated from each other, for example, by regions 1210. The regions 1210 can include the width of the apertured shield surface that contacts the substrate.

In FIG. 12B, the site isolated regions 1275 are closer to each other, separated by regions 1215. The regions 1215 can include the width of the apertured shield surface that contacts the substrate, which can overlap the site isolated regions 1280, for example, at areas 1290.

In some embodiments, combinatorial processes are disclosed in which site isolated regions are surrounded by a temperature controlled apertured shield. The temperature controlled apertured shield can provide additional cooling to the substrate, especially at the site isolated region being processed.

In some embodiments, a combinatorial reactor assembly having a temperature controlled apertured shield can press on a region of the substrate surface to create a site isolated region. The temperature controlled apertured shield can regulate the temperature of the site isolated region to prevent degradation of the deposited film.

In some embodiments, systems and methods for regulating temperature of site isolated regions on a substrate are provided, allowing combinatorial deposition under controlled temperature. A site isolated region can be sealed through a temperature controlled apertured shield, which can be effective for regulating the temperature of the site isolated region, allowing a desired temperature for the deposition process.

In some embodiments, the temperature controlled apertured shield can be used in a high productivity combinatorial (HPC) system. During normal operation of an HPC system, a reactor module including multiple reactors having temperature controlled apertured shields can create multiple site isolated regions on a substrate surface. The site isolated regions then can be processed with process conditions, device structure or materials varying in a combinatorial manner.

In some embodiments, a combinatorial processing chamber can be provided. The combinatorial processing chamber can include a substrate support and a combinatorial reactor assembly, wherein the substrate support is disposed under the combinatorial reactor assembly. The substrate support is configured to receive a substrate and can be coupled to a movement mechanism for rotating, horizontally translating or up/down movements. The combinatorial reactor assembly can include a PVD process mechanism, configured to sputter deposit a layer on one or more site isolated regions on the substrate. A temperature controlled apertured shield can be included to regulate the temperature of the substrate, such as the site isolated regions that are being processed.

A substrate can be introduced to the substrate support, for example, from a loading station, and through a robotic transfer mechanism. The substrate support can be raised up, to be coupled with the apertured shield of the combinatorial reactor assembly. One or more site isolated regions on the substrate can be processed using the combinatorial reactor assembly.

After completing processing, the substrate is lowered to be separated from the combinatorial reactor assembly, and then moved relative to the combinatorial reactor assembly. For example, the substrate or the substrate support can be rotated or translated while the combinatorial reactor assembly is stationary, so that the reactor assembly is positioned at different regions on the substrate surface. Alternatively, the combinatorial reactor assembly can be rotated or translated while the substrate is stationary. In some embodiments, the substrate is moved so that the reactor assembly can be positioned at second substrate surface regions between the first already-processed substrate surface regions. The process can continue, e.g., additional site isolated regions on the substrate can be processed using the combinatorial reactor assembly. The processing can be repeated, for example, until the whole substrate is processed. The apertured shield in the combinatorial reactor assembly can be configured so that the apertured shield can be adjacent or overlapping the site isolated regions that have been processed.

The combinatorial processing technique can be used to develop and investigate materials and processes for device processing and manufacturing. For example, in the combinatorial process, process parameters used to process the one or more regions are varied in a combinatorial manner. Alternatively, at least one region of the one or more regions is processed differently from at least one other region of the one or more regions. For example, different processing times can be used for different site isolated regions.

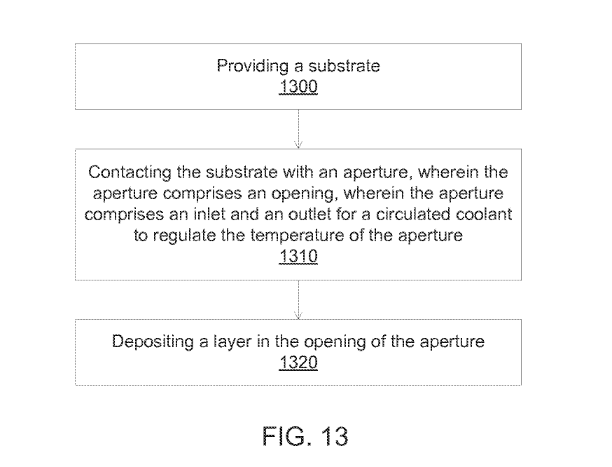

FIG. 13 illustrates a flowchart for processing a substrate according to some embodiments. In operation 1300, a substrate is provided. The substrate can include a glass or ceramic substrate, or a substrate that has low thermal conductivity, e.g., lower than that of a silicon substrate. Other processes can be performed on the substrate, such as a cleaning process, or a bottom electrode deposition for capacitor structure fabrication. In operation 1310, the substrate is contacted by an apertured shield. The apertured shield can be a part of a process assembly, which can include a PVD process mechanism such as a target, power supply and gas sources. The apertured shield can include an opening, which can expose the substrate and form a site isolated region on the substrate. The apertured shield can be temperature controlled, for example, having an inlet and an outlet for a circulated coolant to regulate the temperature of the apertured shield. In operation 1320, a layer can be deposited in the opening of the apertured shield. The layer can be deposited by a PVD process. In some embodiments, the method can further include circulating a gaseous or liquid coolant to the apertured shield, or maintaining the temperature of the apertured shield at room temperature or below 100 C by the circulated coolant.

In some embodiments, multiple site isolation regions are processed on a substrate, with varying materials and process conditions for the different site isolated regions. In some embodiments, structural layers or patterned device structures can be fabricated, including lithographically defined active areas, and lithographically defined metal electrodes, aligned with the active areas.

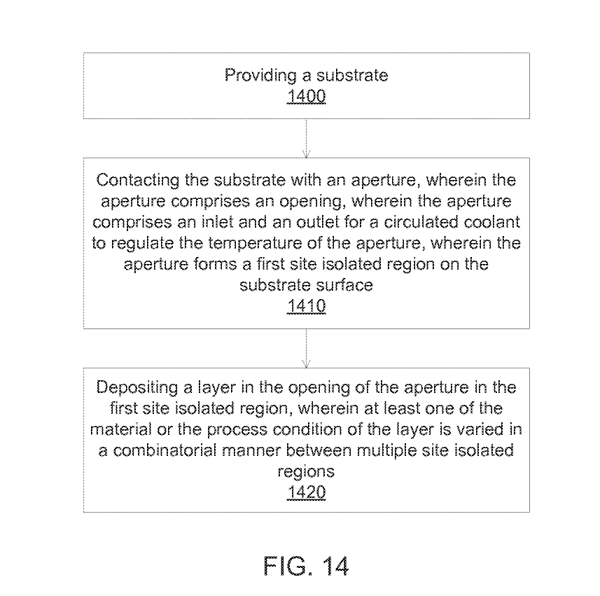

FIG. 14 illustrates a flowchart for combinatorially processing a substrate according to some embodiments. Different dielectric materials, different metal materials, and/or different process conditions using a PVD process can be used to fabricate the layers, including semiconductor devices or low emissivity coatings. The material characteristics and the performance of the layers can provide the properties of the layers, permitting a quick ranking of various materials and process conditions. Poor performance combinations, together with sub-optimum process conditions can be identified and removed without the need to fabricate and test fully-operational devices.

In operation 1400, a substrate is provided. The substrate can include a glass or ceramic substrate, or a substrate that has low thermal conductivity, e.g., lower than that of a silicon substrate. The substrate can be positioned on a substrate support and under a combinatorial reactor assembly. A combinatorial process can be provided to form multiple site isolated regions on the substrate using the combinatorial reactor assembly. In operation 1410, the substrate is contacted by an apertured shield. The apertured shield can be a part of a process assembly, which can include a PVD process mechanism such as a target, power supply and gas sources. The apertured shield can include an opening, which can expose the substrate and form a site isolated region on the substrate. The apertured shield can be temperature controlled, for example, having an inlet and an outlet for a circulated coolant to regulate the temperature of the apertured shield.

In operation 1420, a layer can be deposited in the opening of the apertured shield. The layer can be deposited by a PVD process. In some embodiments, at least one characteristic of the deposited layer, or the PVD process that is used to deposit the layer, can be varied in a combinatorial manner between the site isolated regions. The characteristics can include the thickness of the PVD layer, the composition of the PVD layer, different targets for the PVD process, or different deposition conditions, e.g., deposition time or deposition temperature, of the PVD process. For example, a thickness of the PVD layer in one site isolated region can be 1 nm, and a thickness of the PVD layer in another site isolated region can be 2 nm.

The layer can include a coating for low emissivity panels, such as a protective layer, an oxide layer, a seed layer, or a reflective layer. The protective layer or barrier layer can include silicon nitride, silicon oxynitride, or other nitride material such as SiZrN, for example, to protect other layers from diffusion from the substrate. The oxide layer can include a metal or metal alloy oxide layer and can serve as an antireflective layer. The layer can include a seed layer for an infrared reflective film, for example, a zinc oxide layer deposited before the deposition of a silver reflective layer can provide a silver layer with lower resistivity, which can improve its reflective characteristics. The seed layer can comprise a metal such as titanium, zirconium, and/or hafnium, or a metal alloy such as zinc oxide, nickel oxide, nickel chrome oxide, nickel alloy oxides, chrome oxides, or chrome alloy oxides. The infrared reflective layer can be a metallic, reflective film, such as silver, gold, or copper.

The substrate can be moved relative to the combinatorial reactor assembly. Other site isolated regions on the substrate can continue to be processed using the combinatorial reactor assembly. The layers in multiple site isolated regions can be characterized according to each site isolated regions. The characterization can include structural characterization, such as interface bonding, amorphous layer or polycrystalline layer. The characterization can include optical or electrical characterization. The data related to the performance of the layers or devices can be extracted from the characterization. The optimum layers, including materials and process conditions can be selected based on a comparison of the layer performance.

In some embodiments, the method can further include circulating a gaseous or liquid coolant to the apertured shield, or maintaining the temperature of the apertured shield to be less than 100 C, including at room temperature, by the circulated coolant.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A method for processing a site isolated region, the method comprising
providing a substrate;
contacting the substrate with an apertured shield, wherein the apertured shield comprises an opening, wherein the apertured shield comprises an inlet and an outlet for a circulated coolant to regulate the temperature of the apertured shield;
depositing a layer in the opening of the apertured shield.

2. A method as in claim 1 further comprising
circulating a gaseous or liquid coolant to the apertured shield.

3. A method as in claim 1 further comprising
maintaining the temperature of the apertured shield by the circulated coolant.

4. A method as in claim 1 further comprising
maintaining the temperature of the apertured shield to be less than 100 C by the circulated coolant.

5. A method as in claim 1 wherein the layer is deposited by a Physical Vapor Deposition process.

6. A method as in claim 1 wherein the substrate comprises a glass substrate or a ceramic substrate.

7. A method for processing a site isolated region in a high productivity combinatorial equipment, the method comprising
providing a substrate;
contacting the substrate with an apertured shield, wherein the apertured shield comprises an opening, wherein the apertured shield comprises an inlet and an outlet for a circulated coolant to regulate the temperature of the apertured shield, wherein the apertured shield forms a first site isolated region on the substrate surface;
depositing a first layer in the opening of the apertured shield in the first site isolated region;
moving the apertured shield to a second site isolated region;
depositing a second layer in the opening of the apertured shield in the second site isolated region, wherein at least one of the material or the process condition of the first and second layers is varied in a combinatorial manner between the first and second site isolated regions.

8. A method as in claim 7 further comprising
circulating a gaseous or liquid coolant to the apertured shield.

9. A method as in claim 7 further comprising
maintaining the temperature of the apertured shield by the circulated coolant.

10. A method as in claim 7 further comprising
maintaining the temperature of the apertured shield to be less than 100 C by the circulated coolant.

11. A method as in claim 7 wherein the layer is deposited by a Physical Vapor Deposition process.

12. A method as in claim 7 wherein the substrate comprises a glass substrate or a ceramic substrate.

13. A method as in claim 7 wherein the apertured shield at the second site isolated region does not overlap the first site isolated region.

14. A method as in claim 7 wherein the apertured shield at the second site isolated region overlaps the first site isolated region.

15. A module for combinatorially processing a substrate, comprising:
a target;
an apertured shield facing the target, wherein the apertured shield comprises an opening, wherein the apertured shield comprises an inlet and an outlet, wherein the apertured shield is operable to form a site isolated region on a substrate surface;
a cooling mechanism coupled to the inlet and outlet of the apertured shield, wherein the cooling mechanism is operable to provide a circulated coolant for regulating the temperature of the apertured shield.

16. A module as in claim 15 wherein the apertured shield comprises a material having higher thermal conductivity than that of glass.

17. A module as in claim 15 wherein the apertured shield comprises a material having higher thermal conductivity greater than 1 W/(m·K).

18. A module as in claim 15 wherein the apertured shield comprises a first portion facing the target and a second portion facing the substrate, wherein the first portion comprises a material having higher thermal conductivity smaller than that of the second portion.

19. A module as in claim 15 wherein the apertured shield comprises a removable top portion facing the target.

20. A module as in claim 15 further comprising
a movable shield configured to shield material sputtered from the target from reaching the opening of the apertured shield.
